(19) United States
(12) Patent Application Publication
(10) Pub. No.: US 2013/0213269 A1
(43) Pub. Date: Aug. 22, 2013

(54) PIGMENT DISPERSION AND COLORANT FORMULATION

(71) Applicant: SEYMOUR OF SYCAMORE INC., (US)

(72) Inventor: Garry McCombs, Creston, IL (US)

(73) Assignee: SEYMOUR OF SYCAMORE INC., Sycamore, IL (US)

(21) Appl. No.: 13/791,227

(22) Filed: Mar. 8, 2013

Related U.S. Application Data
(63) Continuation of application No. 13/087,855, filed on Apr. 15, 2011.

(51) Int. Cl. C09D 17/00

(52) U.S. Cl. CPC C09D 17/002
USPC 106/501.1; 106/504

(57) ABSTRACT

A pigment dispersion for use in preparing liquid colorant formulations is based on a blend of fatty acids for use in a point of sale apparatus for charging a pre-pressurized package containing an initial paint formulation having a neutral or clear color to arrive at a matched or selected final color and sold directly to the end user.

### CROSS REFERENCE TO RELATED APPLICATIONS

The present application is a continuation of U.S. patent application Ser. No. 13/087855, filed Apr. 15, 2011. The entire disclosure content of this application is herewith incorporated by reference into the present application.

### BACKGROUND

My invention relates to both a new pigment dispersion composition and a colorant formulation, where the former is used to make the latter and the latter is used in a system to allow for the preparation of a pressurized container of paint formulation of a desired color and gloss at the point of retail sale to the ultimate end user of the product. Specifically, the pigment dispersion formulation of my invention incorporates a blend of fatty acids such that the dispersion is compatible with a filling machine dispenser and with a base paint formulation initially present in a pre-charged pressurized spray container.

One of the most significant developments in the field of paints and other protective coatings is the introduction and development of aerosolized coatings, most commonly referred to as “spray paint.” Retail stores have shelf upon shelf of these pre-filled pressurized containers of complete paint and coatings formulations, in every imaginable color and gloss that are “ready to use”. These complete, pre-packaged spray paint containers provide the customer with a convenient means to purchase small quantities of paint in a readily useable spray container for easy application. Unfortunately, in situations where the end user has a particular color in mind or wants to match a particular existing color, the current art of spray paint forces the end user to select a paint color that in most cases is not the exact color that the user desires. This is because there is no convenient means to allow a consumer to select a color and have that exact color made at the point of purchase. Instead, the user must search a myriad of brands of spray paint in the hope of finding a color that at least comes close to the desired color. Often times, this causes the end user to travel from store to store in search of such a match. Another drawback of the conventional spray paint product is that the inability to prepare a final paint color at the point of sale directly affects the retailer. Because conventional spray paint is only available from the manufacturer in pre-selected and predetermined colors and gloss, the retailer is forced to stock and carry inventory for a large number of cans to accommodate a large number of colors and gloss finishes. This further requires the use of an inordinate amount of shelf space in the store, thus limiting the amount of other products that can be displayed.

A convenient solution to the above mentioned problems would be to allow the retail outlet at the point of sale to formulate the final color of the spray paint based on the end user's selections of color and gloss at the moment of sale. In this way only a very limited number of spray containers containing either a clear or neutral base paint formulation need to be stocked and shelved by the retailer. The end user can then select a final paint formulation that exactly matches his or her needs. Of course, once the final color is selected, there exists the problem of injecting the final paint formulation into the can. In a manufacturing setting large, non-portable paint filling machines are routinely used to inject paint formulations into pre-pressurized containers. However, at the retail level, such machines are non-existent or very rare. Existing paint filling machines are presently available as large bench mounted machines that are pneumatically operated to inject paint and the like into pre-charged aerosol cans. Some examples of these machines are described in U.S. Pat. Nos. 6,302,163, 6,543,490 and 6,138,720 and in the references cited in those two patents. Such machines commonly include a large manually operated lever that is connected to a piston assembly that pneumatically injects a paint formulation from a reservoir through the aerosol valve and into the can. Likewise, U.S. Pat. Nos. 5,740,841; 5,647,408; Des. 361,581; 4,938,260; and 5,535,790, each describe various filing machine designs that can inject a complete “custom” paint formulation into a pressurized can. Other earlier issued U.S. Pat. Nos. 6,705,359, 7,201,191, and 6,135,165 describe pre-pressurized containers filled with a base paint formulation where a final colorant is added to eventually complete a final paint composition at the point of sale, those paint systems suffer from the drawback that the colorant formulation added at the point of sale location is not compatible with the filling machine and/or the initial base paint formulation contained in the pre-pressurized container.

My invention solves the above-mentioned drawback in the point of sale spray paint container systems by starting with a pigment dispersion that results in finished colorant formulations that are compatible with both the filling machine and the initial base paint formulation. This new pigment dispersion relies on the use of a mixture of fatty acids, preferably those found in shea butter.

### SUMMARY

My invention is directed to a new pigment dispersion composition and the resultant colorant formulation made using the pigment dispersion. The colorant is formulated specially for use with a system for preparing a retail store point of sale aerosol paint products, i.e., spray paint containers. The colorant formulation must be compatible with both the filling machine used to prepare the custom spray paint container at a point of sale and the starting base paint (white or neutral in color) contained in the pre-pressurized container. The pigment dispersion relies on the use of a blend of fatty acids, for example, those typically found in natural occurring shea butter, which to my belief has never been incorporated into a pigment dispersion for use in the preparation of spray paints, particularly water borne paint.

In order to prepare a variety of colorant formulations for use with a point of sale spray paint system, it is necessary to disperse pigments in a liquid carrier by means of a liquid pigment dispersion. Each resultant colorant formulation can then be used alone or in combination to arrive at final color of the spray paint selected or matched by the end user at the point of sale.

To form the liquid pigment dispersion of my invention it is necessary to use a blend of fatty acids, particularly those fatty acids selected from the group comprising oleic acid, stearic acid, linoleic acid palmitic acid, linolenic acid, and arachidic acid. Although the exact proportions of these fatty acids are believed not to be critical to my invention, it is preferred that the fatty acid blend be composed of primarily stearic acid and oleic acid. I have found that a convenient means to obtain this blend of fatty acids is to start with shea butter, which is a natural ingredient that is a slightly yellowish or ivory colored natural fat extracted from the seed of the African shea tree (also known as Vitellaria paradoxa, Butyrospermum parkii, B. paradoxa, vitellaria, or karate) by crushing and boiling. The shea fruit consists of a thin, tart, nutritious pulp that surrounds a relatively large, oil-rich seed from which is extracted shea butter. Although it is widely used in cosmetics as a moisturizer and salve, I have found no use of it in pigment dispersions or colorants for spray paint formulations. Shea butter is a complex fat that contains many non-saponifiable components (substances that cannot be fully converted into soap by treatment with alkali.). In particular, shea butter comprises is composed of five principal fatty acids; oleic acid (40-60%); stearic acid (20-50%); linoleic acid (3-11%); palmitic acid (2-9%); linolenic acid (<1%); arachidic acid (<1%). The fatty acid composition is dominated by stearic and oleic acids, which together account for at least 50 wt. %, preferably 85-90 wt. % of the fatty acids. The relative proportions of these two fatty acids produces differences in shea butter consistency. The high stearic acid content gives the shea butter its solid consistency, while the percentage of oleic acid influences how soft or hard the shea butter is, depending on ambient temperature. Shea butter also contains high levels of UV-B absorbing triterpene esters, including cinnamic acid, tocopherols (vitamin A), and phytosterols. Additionally, it contains a high percentage of unsaponifiables, such as phytosterols (campesterol, stigmasterol, beta-sitosterol, and alpha-spinosterol) and triterpenes (cinnamic acid esters, alpha- and beta-amyrin, parkeol, buytospermol, and lupeol), and hydrocarbons such as karitene.

The proportions of stearic and oleic acids in the shea kernels and butter differ across the distribution range of the species. Ugandan shea butter has consistently high oleic acid content, and is liquid at warm ambient temperatures. Ugandan shea butter fractionizes into liquid and solid phases, and is the source of liquid shea oil. The fatty acid proportion of West African shea butter is much more variable than Ugandan shea butter; the oleic content ranges from 37 to 55 wt. %. Variability can even be high in relatively small local populations; a tree that produces hard butter can be located right next to one that produces soft butter. Nuts are gathered from a wide area for local production, so shea butter consistency is determined by the average fatty acid profile of the population. Within West Africa, shea butter from the Mossi plateau region of Burkina Faso has higher average stearic acid content, and was found to be harder than shea butter from other West African regions.

In particular, the colorant formulation of my invention is a liquid composition for use at a point of sale location for injection into a ready to use aerosol container of paint comprising, a blend of fatty acids, a primary pigment, and water. Preferably, the blend of fatty acids comprises shea butter. In another embodiment, my pigment dispersion is a liquid for use in preparing a variety of colorant formulations for use at a point of sale retail location. The pigment dispersion comprises, in combination, a blend of fatty acids (preferably shea butter), a polyamide, hydroxypropyl cellulose, an emulsifier, a long oil vegetable alkyd; and water. Preferably, the emulsifier comprises sorbitan trioleate.

Still further advantages of the present invention will become apparent upon reading and understanding the following detailed description of preferred embodiments.

### DETAILED DESCRIPTION

A critical aspect of providing a complete point of sale spray paint product to the end user is providing a pre-pressurized container containing an initial paint formulation (neutral or white in color) that comprises at a minimum both a paint base and a propellant, whereby as a last step, a colorant formulation is added immediately prior to the purchase by the user of the aerosolized paint. The lastly added colorant must be compatible with both the dispenser apparatus (i.e., paint filling machine) and the initial or base paint formulation contained in the pre-pressurized container. There are several reasons why prior known colorants will not work with a water borne point of sale spray paint system including, inappropriate rheological profiles, the viscosity is too high or too low or is unstable at temperatures expected in the dispenser, unstable color development over time, insufficient air release, brittleness or flaking of dried colorant back into the canisters, hard dry plugs in the dispense orifice, and separation of the liquid phase and settling of solid phase.

Likewise, causes to reject known colorants for use with water-based initial paint formulations contained in the pre-pressurized container include, retardation of the cure schedule, softening of the cured film, down glossing of the cured film due to incompatibility or other issues related to the propellant, down glossing of the cured film due to incompatibility or other issues related to the base paint, non-uniform chemistries of the colorants that prevent formulation of a satisfactory base paint, some colorants detract from weathering ability, chemical resistance, and physical properties such as hardness or flexibility, and insufficient representation of the visible spectrum.

Pressurized cans or containers containing an initial paint formulation are provided to a retail store outlet from a manufacturer. Immediately prior to the sale, the ultimate end user of the spray paint selects a final color and gloss level in order to complete the final spray paint product. Typically, the final color of the spray paint is selected by the end user based on matching of an existing color or type of paint previously purchased by the user or by selecting a desired color from a color palette, such as, a color wheel, paint swatches, or paint chips. The user may also select or request a preferred gloss level. For each color that can be selected from a color palette there will be a corresponding predetermined recipe of colorant formulations that can be used to arrive at the desired color. Alternatively, the user may want to match an existing color based on a sample of a color that they would bring with them to the point of sale. This is achieved by simply comparing the known color provided by the user to a color wheel or to paint swatches, or by using a spectrophotometer or other automated system to match colors. Typically, such an automated procedure involves providing a sample of a known color for analysis by a spectrometer whereby the exact sample color is determined and reported to either the end user or the retail store operator or directly to a computer controlled filling machine. U.S. Pat. No. 6,400,906, which is incorporated fully herein by reference, discloses a paint matching process and apparatus that could be adapted to arrive at a suitable recipe for the colorant formulations of my invention.

Using the predetermined recipe for the selected color, one or more colorant formulations can be used to inject into the base paint contained in the pre-pressurized container to arrive at the correct color for the finished product. The colorant formulations, using the liquid pigment dispersion of my invention, can be prepared at the point of sale location, or more conveniently can be supplied to the point of sale location as a pre-formulated package of colorant either as single-use amounts or for use in reservoirs of dispensable colorants. In some cases, the recipe calls for the mixing of two or more colorant formulations to be injected by the dispensing apparatus into the pre-pressurized container. Injecting the colorants into the pre-pressurized container can be done sequentially directly into the container or into a mixing vessel where once all the required colorants and ingredients are in the vessel, then all the ingredients are simultaneously injected in a single step into the container. The recipe can be based either on volumetric or weighed amounts of colorants and other ingredients. Whether added as a single injectable amount of liquid or sequential amounts of individual components, the filling machine adds the colorants of my invention to the pressurized container through a filling opening in the pressurized container to achieve the desired final color selected by the end user. Additionally, flattening dispersions may be added to achieve the desired gloss level. A gloss meter is typically employed to measure the gloss level, preferably at approximately a 60 degree angle. Flattening dispersions are added to modify the gloss level to the desired finish.

As mentioned, it has been surprisingly found that inclusion of a blend of fatty acids, preferably in the form of shea butter, into a liquid pigment dispersion that is then used to prepare colorant formulations eliminates or substantially reduces the problems encountered with known colorants when used in a point of sale spray paint system. Preferably, the amount of shea butter present used in the in my colorant formulations varies depending on the particular type and amount of primary pigment used, but generally is in the range from about 0.025 wt. % to about 50 wt. %, preferably about 0.2 wt. % to about 0.5 wt. %, and more preferably from about 0.35 wt. % to about 0.45 wt. %. A particularly preferred shea butter is Jarplex SB-WD manufactured and sold by Jarchem Industries, Inc. However, as mentioned, my invention is not limited to the use of a particular shea butter (natural or artificial), but is directed to a blend of two or more fatty acids selected from the group consisting of oleic acid, stearic acid, linoleic acid palmitic acid, linolenic acid, and arachidic acid.

Starting with the liquid pigment dispersion of my invention one or more pigments are added to arrive at a desired colorant formulation. Pigment is typically a coloring material usually a finely ground powder which does not dissolve. It is suspended in a liquid solvent vehicle, water or oil-based, and becomes the coloring material in the final paint formulation. Typically, there are two types of pigments used in paint formulation, prime or primary pigments and extender pigments. Primary pigments are what provide the primary coloration of the paint whether white or a color shade. Extender pigments (also “extenders”) are the filler used in paint pigment. They do not hide as well as primary pigments, but have a significant impact on the overall characteristics and performance of a paint, including hiding, durability, scrubbability and retention of color. Extender pigments have historically been made from clay, silica, talc, chalk, and to assist in mildew prevention, zinc oxide, however, recently microspheric ceramic beads have been used in place of traditional extenders.

Examples of the primary pigments that are used in the colorant formulations of my invention include, but are not limited to titanium dioxide, carbon black, phthalocyanines, molybdates, quinacridones, iron oxide and other known pigments. The specific amounts of primary pigments included in the colorant formulation correspond to the many possible final colors that are eventually selected by the end-user. For example, if the final desired color was selected to be ASA 61 Gray then the predetermined recipe corresponding to that particular gray color is 50 g of white (TiO₂); 2.5 g yellow oxide; 1.95 g black; and 0.26 g blue dispersions. As long as the weight ratios of these colors are added to the container, taking into account the starting color of the initial point formulation in the pressurized container, the desired gray color will be achieved. In other words, if the initial paint formulation chosen contains the white base, then the amount of TiO₂ tint added must be adjusted to take into account the TiO₂ already present in the initial paint formulation such that the above weight ratios of different tints remains constant.

In addition to the blend of fatty acids, my pigment dispersion uses water as the primary liquid carrier for the other ingredients in the dispersion. Additional ingredients include an emulsifier, such as, sorbitan trioleate (C₆₀H₁₀₈O₈) otherwise known as T-Sol 85 or Span 85. The emulsifier can be present in the range from about 0.025 wt. % to about 50.0 wt. %, preferably in the range from about 0.75 wt. % to about 1.6 wt. %, and more preferably from about 1.1 wt. % to about 1.5 wt. %. Additionally, hydroxypropyl cellulose can be included in the colorant formulation to provide binding and rheology properties. A preferred hydroxypropyl cellulose is Klucel L manufactured and sold by Ashland Aqualon and is present in the range from about 0.3 wt. % to about 0.6 wt. %, and more preferably from about 0.4 wt. % to about 0.5 wt. %.

Yet another possible ingredient in the colorant formulation of my invention is a long oil alkyd used as a binder to improve the dispensing properties of the colorant formulation. An alkyd is a polyester modified by the addition of fatty acids and other components. They are derived from polyols and a dicarboxylic acid or carboxylic acid anhydride. The inclusion of the fatty acid confers a tendency to form flexible coating.

Long oil alkyds have a high percentage of drying oil content, i.e., triglycerides derived from polyunsaturated fatty acids (often derived from plant and vegetable oils, e.g. linseed oil) and are cured in air. Typical sources of drying oils for alkyd coatings are sunflower oil, safflower oil, walnut oil, soybean oil, fish oil, corn oil, and tall oil (resinous oil by-product from pulp and paper manufacturing). A preferred long oil alkyd is Beckosol AQ-101 manufactured and sold by Reichhold and is present in the range from about 8.5 wt. % to about 15.25 wt. %, and more preferably from about 10.5 wt. % to about 14.0 wt. %.

A polyamide can also be used in my colorant formulation to provide binding and rheology properties. A preferred polyamide is Disparlon AQ-607 manufactured and sold by King Industries and is present in the range from about 0.25 wt. % to about 0.6 wt. %, and more preferably from about 0.35 wt. % to about 0.5 wt. %.

Product enhancers, such as thickeners, corrosion inhibitors and flow modifiers, may also be added by the filling machine into the initial paint formulation without departing from the spirit of the disclosure for the scope of the appended claims. Total miscellaneous paint enhancers will generally constitute less than about 5% by weight of the total aerosol can content. These are preferably added during the preparation of the aerosolized container containing the initial paint formulation prior to the addition of the colorant formulation of my invention or other additives at the point of sale. Thickeners are employed as an ingredient because of their marked increase in the viscosity of the composition which prevents the occurrence of undesirable “running” of the wet paint film when it is sprayed onto a slanted or vertical surface. A wide variety of acrylic emulsion thickening agents are commercially available. One example is Kings PUR 60. An example of a commercially available corrosion inhibitor is AMP-95 and example of a commercially available flow modifier is any fluorosurfactant.

One example of a colorant formulation of my invention could include the following ingredients:
1) De-ionized water as the carrier for the other components.
2) Primary pigments in the form of various chemistries (various suppliers) to impart specific spectral or color attributes.
3) Barium sulfate in the form of Huberbrite 1 (Huber) offers cost reductions by improving the hiding power of, or reducing the required amount of primary pigments.
4) A mixture of alkylolammonium salt of a polycarboxylic acid and a polysiloxane copolymer in the form of Lactimon-WS (Byk-Chemie) aids the uniform distribution of pigment particles.
5) A blend of fatty acids in the form of water reducible Shea Butter (Jarchem SB-WD) acts as an emollient assisting in water clean-up of dried spills.
6) An ethoxylated undecyl alcohol in the form of Genapol UD 079 (Clariant) assists in cutting the waxy nature of Shea Butter.
7) Sorbitan Trioleate in the form of T-Sol 85 ( ), in conjunction with the Genapol UD 079, disperses and or emulsifies the Shea Butter into its water carrier.
8) A polyamide thixotrope in the form of Disparlon AQ-607 (King Industries) imparts specific rheological properties. This is supplied in the form of a intermediate comprised of,
   a) De-ionized water
   b) Disparlon AQ-607
   c) Tego 901W (Goldschmidt-Degussa)—a de-aerator that improves application properties for the finished paint
   d) AMP-95 (Angus)—as pH adjustment and in can anti-corrosive
   e) Nuosept 95 (International Specialty Products)—a biocide
9) Hydroxypropyl cellulose in the form of Klucel L (Ashland) is used to retard shrinkage of dried colorant, reducing or eliminating a tendency to mud-crack.
10) An organo-silicone defoamer in the form of D-Foam-R C740 (Clariant) is introduced in the pigment dispersion stage to retard incorporation of air bubbles.
11) A synthetic defoamer in the form of D-Foam-R C330 (Clariant) is used in the letdown portion to assist in the release of remaining entrapped air.
12) A long oil alkyd emulsion, currently in the form of Beckosol AQ-101 (Reichhold) is a non-film forming binder except in the presence of metallic driers.
13) The pH of the product is adjusted with an amine in the form of AMP-95 (Angus) helps prolong the water solubility of the long oil alkyd.

It should be understood that the embodiments and examples disclosed herein are presented for illustrative purposes only and that many other combinations and articles that embody the methods, formulations and systems will be suggested to persons skilled in the art and, therefore, the invention is to be given its broadest interpretation within the terms of the following claims: The invention has been described with reference to preferred embodiments. Obviously, modifications and alterations will occur to others upon reading and understanding the preceding specification. It is intended that the invention be construed as including all such alterations and modifications insofar as they come within the scope of the appended claims or the equivalents thereof.

1. A liquid colorant formulation for use at a point of sale location for injection into a ready to use aerosol container of paint consisting essentially of,
a) a blend of fatty acids;
b) a primary pigment; and
c) water;
wherein the blend of fatty acids, primary pigment, and water are formulated as a single package to allow the package to be injected into and mixed with a base paint contained in a pressurized container in order to prepare a ready to use aerosol container of paint at a point of sale location.

2. The formulation of claim 1 where the blend of fatty acids comprises fatty acids selected from the group consisting of oleic acid, stearic acid, linoleic acid palmitic acid, linolenic acid, and arachidic acid.

3. The formulation of claim 1 where the blend of fatty acids comprises at least 50 wt. % stearic acid and oleic acid.

4. The formulation of claim 1 where the blend of fatty acids comprises shea butter.

5. The package of claim 1 further comprising hydroxypropyl cellulose.

6. A pigment dispersion for use in preparing a liquid colorant for use at a point of sale location for injection into a ready to use water-borne aerosol container of paint consisting essentially of, in combination,
a) a blend of fatty acids comprising at least 50 wt. % stearic acid and oleic acid;
b) a polyamide;
c) hydroxypropyl cellulose;
d) an emulsifier;
e) a long oil vegetable alkyd;
f) a primary pigment and
g) water,
wherein the dispersion is formulated into a single package to allow the package to be injected into and mixed with a base paint contained in a pressurized container in order to prepare a ready to use aerosol container of water-borne paint at a point of sale location.

7. The dispersion of claim 6 where the blend of fatty acids comprises shea butter.

8. The dispersion of claim 6 wherein the emulsifier comprises sorbitan trioleate.
